(19) United States
(12) Patent Application Publication
(10) Pub. No.: US 2006/0010130 A1
(43) Pub. Date: Jan. 12, 2006

(54) Method and apparatus for synchronizing client transactions executed by an autonomous client

(76) Inventors: Avraham Leff, New Hempstead, NY (US); James Thomas Rayfield, Ridgefield, CT (US)

Correspondence Address: Moser, Patterson & Sheridan, Suite 100, 595 Shrewsbury Avenue, Shrewsbury, NJ, 07702, US

(21) Appl. No.: 10/888,811

(22) Filed: Jul. 9, 2004

(51) Int. Cl. G06F 17/30

(52) U.S. Cl. 707/8

(57) ABSTRACT

One embodiment of the present method and apparatus for synchronization of client transactions executed by an autonomous client enables a client operating on a limited connection to a server to log transactions executed against a locally stored server database state. Logged transactions are then synchronized with a current server database state by delivering the transaction log to the server, which re-executes each logged client transaction against the current server database state, thereby reducing synchronization-related transaction conflicts.

### BACKGROUND

The present invention relates generally to application-based transaction processing, and relates more particularly to the synchronization of transactions executed by a client while operating on a limited connection to a server with the server's current state.

FIG. 1 is a schematic diagram illustrating one embodiment of a distributed client-server environment 100, wherein one or more client machines 102₁-102ₙ (hereinafter collectively referred to as “clients 102”) execute transactions in association with a server that maintains a “master” copy of data used by transactional applications running on the clients 102. The clients 102 are connected to the server 104 via respective communication links 106₁-106ₙ, which, at times, may provide only limited connection to the server 104. Thus, it is often necessary for a client 102 to operate while not fully connected to the server. During this time, the client is able to execute transactions only against a locally cached server database state, which may be outdated or represent only a subset of the whole database.

When a full connection is re-established, changes made to the cached server state by the client must be synchronized with a current server state. One conventional way to accomplish this is to copy the modified state data from the client to the server. A problem with such conventional techniques, however, is that they maintain neither the transactional boundaries that existed on the “disconnected” client, nor the transactional order that existed on the disconnected client. In addition, client transactions that are committed to the server were originally committed against a state that is no longer current with respect to the server. Moreover, certain dependency cycles that correspond to invalid transactions are not detected, meaning that the corresponding transactions are improperly committed. Finally, certain transactions are aborted because the client state conflicts with the current server state, yet if the transactions were run against the current server state, they would execute properly.

Thus, there is a need in the art for a method and apparatus for synchronizing client transactions executed by an autonomous client.

### SUMMARY OF THE INVENTION

In one embodiment, the present invention is a method and apparatus for synchronization of client transactions executed by an autonomous client. One embodiment of the present invention enables a client operating on a limited connection to a server to log transactions executed against a locally stored server database state. Logged transactions are then synchronized with a current server database state by delivering the transaction log to the server, which re-executes each logged client transaction against the current server database state, thereby reducing synchronization-related transaction conflicts.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating one embodiment of a distributed client-server environment;

FIG. 2 is a flow diagram illustrating one embodiment of a method for executing transactional applications while operating on a limited connection to a server according to the present invention;

FIG. 3 is a flow diagram of one embodiment of a method for synchronizing a client transaction log with a current server database state, according to the present invention; and

FIG. 4 is a high level block diagram of the present invention implemented using a general purpose computing device.

To facilitate understanding, identical reference numerals have been used, where possible, to designate identical elements that are common to the figures.

### DETAILED DESCRIPTION

In one embodiment, the present invention is a method and apparatus for synchronization of client business logic executions (e.g., business transactions and methods) executed by an autonomous client. Embodiments of the present invention enable a client operating on a limited connection to a server to log transactions executed against a locally stored server database state. Logged transactions are then synchronized with a current server database state by delivering the transaction log to the server, who re-executes each logged client transaction against the current server database state, thereby reducing synchronization-related transaction conflicts.

For the purposes of the present invention, the term “limited connection” may mean that the client is completely disconnected from the server, or that the connection is simply too limited (e.g., due to slow speed or high latency) to allow the client to send updates to the server after every transaction. For example, if the client is executing on a mobile computing device such as a personal digital assistant, a cellular telephone or a hand-held or laptop computer, the device typically will operate, at least part of the time, without interacting with the server. Embodiments of the present invention are described in terms of transactional applications, e.g., business applications, which are characterized by periodic updates to a state, e.g., stored on a server, which is shared by multiple clients, wherein the updates are performed transactionally.

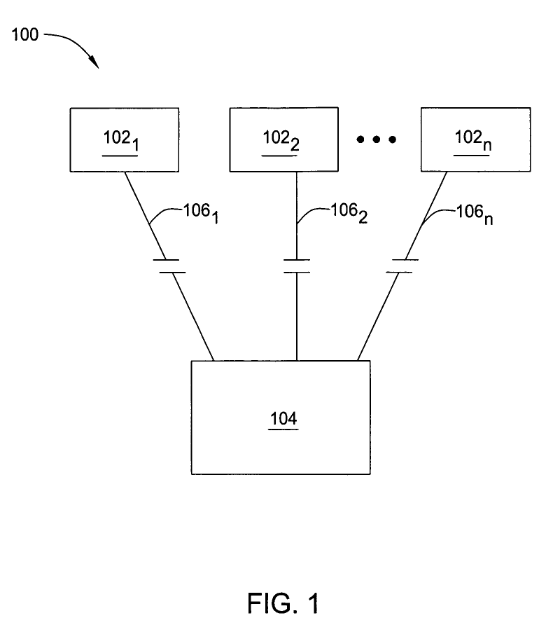

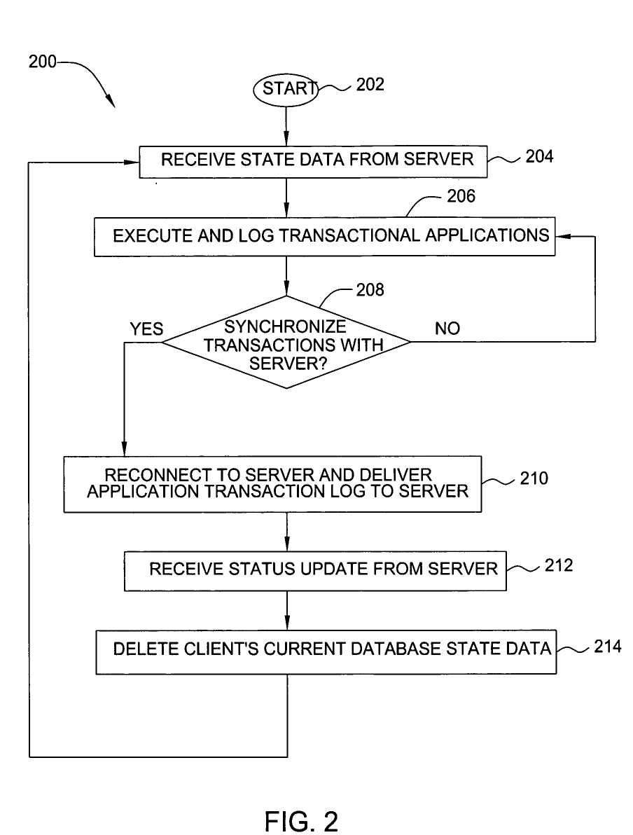

FIG. 2 is a flow diagram illustrating one embodiment of a method 200 for executing transactional applications (e.g., business applications such as item orders) while operating on a limited connection to a server according to the present invention. The method 200 thus may be implemented, for example, when no network or no connection exists, or where communication between the client and the server is made impractical due to network latency limitations. In one embodiment, the method 200 is executed by a client, e.g., a client 102 as illustrated in FIG. 1 and comprising one or more transactional applications that are capable of execution when the client is not fully connected to the server.

The method 200 is initialized at step 202 and proceeds to step 204, where the method 200 receives a copy of the current server database state (or a relevant subset thereof) from the server. For example, in one embodiment, one transactional application residing at the client is an order-entry application (e.g., for ordering items for purchase), and a corresponding server database state might comprise one or more of orderable items, customers, stock levels and pending orders. A database state received in step 204 may comprise a subset of this information (e.g., only information pertaining to customers serviced by the receiving client).

In one embodiment, the method 200 receives the current server database state data in response to a request issued to the server. In one embodiment, step 204 is executed while the client is fully connected to the server. In one embodiment, a “full” client-server connection is one in which latency and bandwidth permit the client to synchronize with the server within a reasonable period of time, where a “reasonable” period of time is defined by the transactional application that is executed and the device being used to execute the transactions (e.g., a reasonable amount of time could be a matter of minutes for a portable device, or overnight for a departmental server) In one embodiment, step 204 includes receiving all current server database state data that is relevant to the transactional applications that the client is currently executing. In one embodiment, the client stores the received server database state data on a local database (e.g., a persistent client database) that is accessible by the one or more transactional applications to modify the server database state data contained therein.

In step 206, the method executes one or more transactional applications against the stored server database state that was received in step 204 and logs each transaction (e.g., logs business logic executions for each transaction). In one embodiment, logging of the transactions in step 206 captures the execution of business logic on the client, as opposed to merely values (e.g., before or after) of the database records. Thus, a log entry for each transaction includes enough information to allow the server to replay or re-execute the transaction at a later time, as discussed in further detail below. In one embodiment, a log entry for each transaction includes at least one of the following: a name (or other identifier, e.g., “PlaceOrder”) for the transaction, input parameters for the transaction (other than the resultant database state, e.g., set of [item, count], customer identifier), and the transaction's result value. In one embodiment, the transactional applications are executed and logged while the client is operating over a limited connection to the server (e.g., the client is operating substantially autonomously). In one embodiment, each transaction is executed and logged by logging middleware residing on the client that tracks the methods of the transactional applications as they execute.

In step 208, the method 200 decides whether or not to synchronize the client's log of executed transactions with the server (e.g., with a current server database state). In one embodiment, the decision to synchronize the log of executed transactions is based on the availability and/or the quality of a network connection between the client and the server (e.g., in one embodiment, if a high quality connection is available, the method 200 chooses to synchronize). If the method 200 decides not to synchronize the client's log with the server, the method 200 returns to step 206 and continues to execute and log transactional applications. Alternatively, if the method 200 does decide to synchronize the client's log with the server, the method 200 proceeds to step 210, where the method 200 reconnects (e.g., re-establishes a full connection from) the client to the server and delivers the log of executed methods to the server.

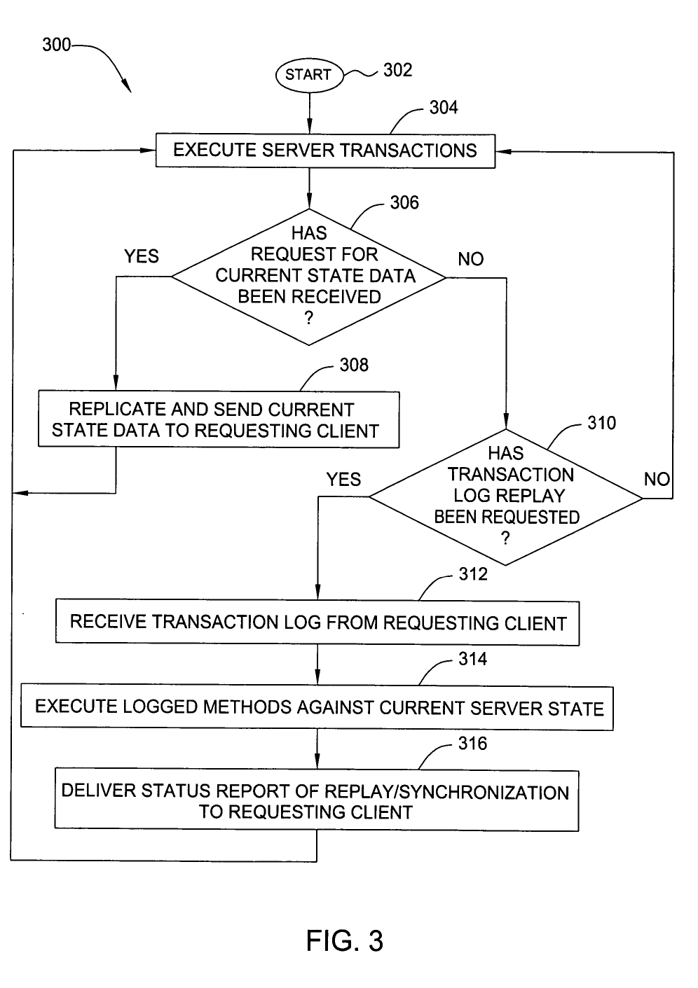

The log of executed methods is received and processed by the server as described in further detail below with reference to FIG. 3. Once the log of executed methods has been processed by the server, the method 200 receives a status update from the server in step 212. In one embodiment, the received status update includes the status of the data synchronization. In another embodiment, the received status update includes an instruction to empty the client's server database state cache and load a current server database state (or relevant subset thereof).

Once the method 200 receives the status update, the method 200 proceeds to step 214 and deletes the client's locally stored server database state data (e.g., the now-outdated server database state data received from the server in step 204). The method 200 then returns to step 204 and receives an updated copy of the server database state (e.g., the now current state) so that the method 200 can continue to execute one or more transactional applications. In one embodiment, the method 200 optimizes execution of step 214 and the subsequent return to step 204 by deleting only obsolete or out-dated state data in step 214.

FIG. 3 is a flow diagram of one embodiment of a method 300 for synchronizing a client transaction log with a current server database state, according to the present invention. In one embodiment, the method 300 is executed by a server (e.g., the server 104 of FIG. 1).

The method 300 is initialized at step 302 and proceeds to step 304, where the method 300 executes server transactions, e.g., in accordance with a default server state. In step 306, the method 300 determines whether or not a request for current server database state data has been received, e.g., from a client. If the method 300 concludes that such a request has been received, the method 300 proceeds to step 308, where the method 300 replicates or copies the current server database state and sends the replicated data to the requesting client.

Alternatively, if a request for current server database state data has not been received, the method 300 proceeds to step 310 and determines whether or not a request to replay a particular client's transaction log has been received. If no such request has been received, the method 300 returns to step 304 and executes server transactions, e.g., in accordance with the default state.

However, if the method 300 concludes in step 310 that a request to replay a particular client's transaction log has been requested, the method 300 proceeds to step 312 and receives the relevant transaction log from the requesting client (e.g., where the client has logged transactions made while operating over a limited connection to the server in accordance with step 206 of the method 200). The method 300 then proceeds to step 314 and re-executes the logged methods from the received transaction log against the current server database state. In one embodiment, the logged methods are re-executed one-by-one until all logged methods have been re-executed against the current server database state. In one embodiment, replay middleware residing at the server enables the server to process the client's logged transactions.

In one embodiment, re-execution result values are compared against original client result values logged for each transaction, and comparison results indicate whether or not the re-execution is valid according to pre-defined criteria.

In step 316, the method 300 delivers a status report of the re-execution/synchronization step 314 to the client whose log was re-executed. The method 300 then returns to step 304 and executes server transactions, e.g., in accordance with the default state.

Thus, rather than simply uploading a modified database state from the client (which will likely not reflect the server's actual current database state), the server uploads the transactional methods executed by the client against the stored database state. Because the client transactions are then individually re-executed against the current server database state rather than automatically committed against the current server database state en masse, transactions may be more readily evaluated before they are erroneously committed or aborted. This also enables original transaction boundaries to be maintained and substantially eliminates dependency cycles.

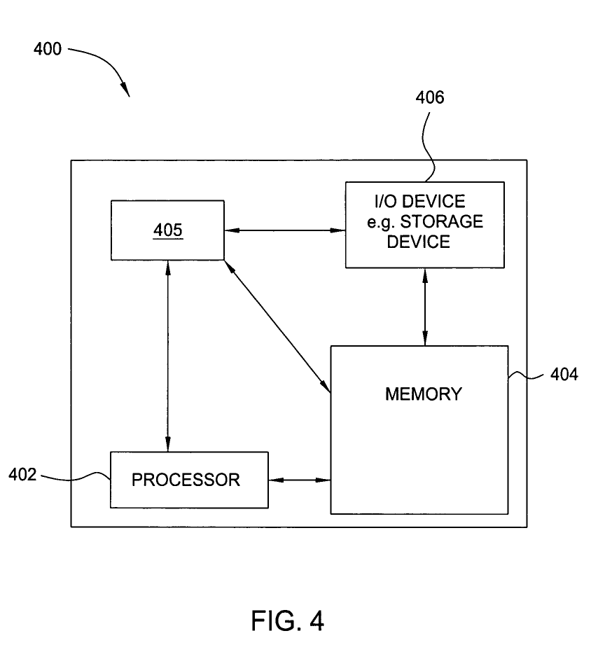

FIG. 4 is a high level block diagram of the present transaction synchronization method that is implemented using a general purpose computing device 400. In one embodiment, a general purpose computing device 400 comprises a processor 402, a memory 404, a transaction synchronization module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the transaction synchronization module 405 can be implemented as a physical device or subsystem that is coupled to a processor through a communication channel.

Alternatively, the transaction synchronization module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the transaction synchronization module 405 for synchronizing executed transactions described herein with reference to the preceding Figures can be stored on a computer readable medium or carrier (e.g., RAM, magnetic or optical drive or diskette, and the like).

In one embodiment, the present invention is deployed within a Java 2 Platform, Enterprise Edition (J2EE) or Enterprise JavaBean (EJB) application environment. For example, the present invention may be deployed within any one the frameworks described by A. Leff et al., “Enterprise JavaBeans and Microsoft Transaction Server: Frameworks for Distributed Enterprise Components”, Advances in Computers, Academic Press, Vol. 54, pp. 99-152, 2001, which is incorporated herein by reference. In other embodiments, the present invention is deployed within any framework for distributed enterprise components or any object-oriented environment in which it is desirable for clients to execute transactional applications while operating over a limited server connection.

Thus, the present invention represents a significant advancement in the field of application-based transaction processing. A method and apparatus are provided that enable a client that is operating substantially autonomously to maintain a log of executed transactions. When the client re-establishes a full connection to the server, the server re-executes the logged transactions, thereby ensuring that no transactions are erroneously committed to the server database or aborted. Conflicts commonly encountered in conventional client-server synchronization processes are therefore substantially eliminated.

While foregoing is directed to the preferred embodiment of the present invention, other and further embodiments of the invention may be devised without departing from the basic scope thereof, and the scope thereof is determined by the claims that follow.

1. A method for synchronizing one or more transactional applications executed by a client against a transaction database of an associated server, the method comprising the steps of:
caching data representing at least a portion of a current state of said server transaction database;
recording one or more transactional business logic executions executed against the cached data in a client transaction log, where said client operates substantially autonomously when said transactions are executed; and
delivering said transaction log to said server when said client re-establishes a full connection with said server.

2. The method of claim 1, wherein said transaction log comprises at least one of the following for each recorded business logic execution: a name for the business logic execution, input parameters for the business logic execution and the business logic execution's result value.

3. The method of claim 1 wherein said caching step comprises:
requesting said data from said server; and
receiving said data from said server in response to said request.

4. The method of claim 1, wherein said data represents a subset of said server's current state.

5. The method of claim 1, wherein said client comprises one or more transactional applications that are capable of execution when said client operates substantially autonomously.

6. The method of claim 1, further comprising the steps of:
receiving a status update from said server, wherein said status update represents an updated server transaction database state reflecting the extent to which said recorded business logic executions were synchronized with said server transaction database at said server; and
deleting the cached server transaction database state data.

7. The method of claim 6, further comprising the step of:
replacing the deleted server transaction database state data with data representing the updated server transaction database state.

8. The method of claim 1, wherein said client is not connected to said server when said business logic executions are executed and recorded.

9. The method of claim 1, wherein said substantially autonomous operation of said client is attributable to at least one of slow connection speed and high latency.

10. A computer readable medium containing an executable program for synchronizing transactional applications executed by a client against a transaction database of an associated server, where the program performs the steps of:
caching data representing at least a portion of a current state of said server transaction database;
recording one or more transactional business logic executions against the cached data in a client transaction log, where said client operates substantially autonomously when said transactions are executed; and
delivering said transaction log to said server when said client re-establishes a full connection to said server.

11. The computer readable medium of claim 10, wherein said transaction log comprises at least one of the following for each recorded business logic execution: a name for the business logic execution, input parameters for the business logic execution and the business logic execution's result value.

12. The computer readable medium of claim 10 wherein said caching step comprises:
requesting said data from said server; and
receiving said data from said server in response to said request.

13. The computer readable medium of claim 10, wherein said data represents a subset of said server's current state.

14. The computer readable medium of claim 10, wherein said client comprises one or more transactional applications that are capable of execution when said client operates substantially autonomously.

15. The computer readable medium of claim 10, further comprising the steps of:
receiving a status update from said server, wherein said status update represents an updated server transaction database state reflecting the extent to which said recorded business logic executions were synchronized with said server transaction database at said server; and
deleting the cached server transaction database state data.

16. The computer readable medium of claim 15, further comprising the step of:
replacing the deleted server transaction database state data with data representing the updated server transaction database state.

17. The computer readable medium of claim 10, wherein said client is not connected to said server when said business logic executions are executed and recorded.

18. The computer readable medium of claim 10, wherein said substantially autonomous operation of said client is attributable to at least one of slow connection speed and high latency.

19. An apparatus for synchronizing transactional applications executed by a client against a transaction database of an associated server, comprising:
means for caching data representing at least a portion of a current state of said server transaction database;
means for recording one or more transactional business logic executions executed against the cached data in a client transaction log, where said client operates substantially autonomously when said business logic executions are executed; and
means for delivering said transaction log to said server when said client re-establishes a full connection to said server.

20. The apparatus of claim 19, wherein said apparatus is deployed within a framework for distributed enterprise components.

21. The apparatus of claim 20, wherein said apparatus is deployed within at least one of an Enterprise JavaBeans or Java 2 Platform, Enterprise Edition system.

22. A method for synchronizing one or more transactional business logic executions executed by a client with a current state of a transaction database residing at a server, the method comprising the steps of:
receiving a transaction log from said client, wherein said transaction log comprises one or more transactional business logic executions executed by said client while said client operates substantially autonomously; and
re-executing each recorded business logic execution against said transaction database.

23. The method of claim 22, wherein business logic executions recorded in said log are re-executed one-by-one.

24. The method of claim 22, further comprising the steps of:
receiving a request from said client to transmit data representing a current state of said transaction database, prior to receiving said transaction log; and
delivering, in response to said request, said data to said client.

25. The method of claim 22, further comprising the steps of:
delivering a status report to said client, wherein said status report represents an updated transaction database state reflecting the extent to which said business logic executions recorded by said client were synchronized with said transaction database at said server.

26. The method of claim 22, wherein said transaction log comprises at least one of the following for each business logic execution: a name for the business logic execution, input parameters for the business logic execution and the business logic execution's result value.

27. A computer readable medium containing an executable program for synchronizing one or more transactional business logic executions executed by a client with a current state of a transaction database residing at a server, where the program performs the steps of:
receiving a transaction log from said client, wherein said transaction log comprises one or more transactional business logic executions executed by said client while said client operates substantially autonomously; and
re-executing each business logic execution recorded in said log against said transaction database.

28. The computer readable medium of claim 27, wherein business logic executions recorded in said log are re-executed one-by-one.

29. The computer readable medium of claim 27, further comprising the steps of:
receiving a request from said client to transmit data representing a current state of said transaction database, prior to receiving said transaction log; and
delivering, in response to said request, said data to said client.

30. The computer readable medium of claim 27, further comprising the steps of:
delivering a status report to said client, wherein said status report represents an updated transaction database state reflecting the extent to which said business logic executions recorded by said client were synchronized with said transaction database at said server.

31. The computer readable medium of claim 27, wherein said transaction log comprises at least one of the following for each recorded business logic execution: a name for the business logic execution, input parameters for the business logic execution and the business logic execution's result value.

32. An apparatus for synchronizing one or more transactional business logic executions executed by a client with a current state of a transaction database residing at a server, comprising:
means for receiving a transaction log from said client, wherein said transaction log comprises one or more transactional business logic executions executed by said client while said client operates substantially autonomously; and
means for re-executing each business logic execution recorded in said log against said transaction database.

33. The apparatus of claim 32, wherein said apparatus is deployed within a framework for distributed enterprise components.

34. The apparatus of claim 33, wherein said apparatus is deployed within at least one of an Enterprise JavaBeans or Java 2 Platform, Enterprise Edition system.
